(19) United States
(12) Patent Application Publication
(10) Pub. No.: US 2001/0015751 A1
(43) Pub. Date: Aug. 23, 2001

(54) Method and apparatus for omnidirectional imaging

(75) Inventor: Zheng J. Geng, Rockville, MD (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Genex Technologies, Inc.

(21) Appl. No.: 09/821,648

(22) Filed: Mar. 29, 2001

Related U.S. Application Data
(63) Continuation-in-part of application No. 09/098,322, filed on Jun. 16, 1998.
(60) Provisional application No. 60/193,246, filed on Mar. 30, 2000.

(51) Int. Cl. H04N 7/00

(52) U.S. Cl. 348/36; 348/61

(57) ABSTRACT

An omnidirectional imaging apparatus obtains images over an entire hemispherical field and uses a mapping matrix to define a relationship between pixels in a user-defined perspective or panoramic viewing window and pixel locations on the original omnidirectional image. This allows the computation of non-distorted images in real-time without relying on complex high-order non-linear equations.

### REFERENCE TO RELATED APPLICATIONS

This application claims the benefit of U.S. Provisional application Ser. No. 60/193,246, filed Mar. 30, 2000, which is a continuation-in-part of co-pending U.S. application Ser. No. 09/098,322, filed Jun. 16, 1998, the disclosures of which are incorporated by reference herein in their entirety.

### TECHNICAL FIELD

The invention is related to omnidirectional imaging and transmission, and more particularly to an omnidirectional imaging method and apparatus that obtains images over an entire hemispherical field of view simultaneously and a corresponding image viewing scheme.

### BACKGROUND OF THE INVENTION

A number of approaches had been proposed for imaging systems that attempt to achieve a wide field-of-view (FOV). Most existing imaging systems employ electronic sensor chips, or still photographic film, in a camera to record optical images collected by the camera's optical lens system. The image projection for most camera lenses is modeled as a “pin-hole” with a single center of projection. Because the sizes of the camera lens and the imaging sensor have their practical limitations, the light rays that can be collected by a camera lens and received by the imaging device typically form a cone with a very small opening angle. Therefore, angular field-of-views for conventional cameras are within a limited range ranging from 5 to 50 degrees. This limited range makes conventional cameras unsuitable for achieving a wide FOV, as can be seen in FIG. 1.

Wide-viewing-angle lens systems, such as fish-eye lenses, are designed to have a very short focal length which, when used in place of conventional camera lens, enables the camera to view objects at much wider angle to obtain a panoramic view, as shown in FIG. 1. In general, to widen the FOV, the design of the fish-eye lens is made more complicated. As a result, obtaining a hemispherical FOV would require the fish-eye lens to have overly large dimensions and a complex, expensive optical design. Further, it is very difficult to design a fish-eye lens that conforms to a single viewpoint constraint, where all incoming principal light rays intersect at a single point to form a fixed viewpoint, to minimize or eliminate distortion. The fish-eye lens allows a statically positioned camera to acquire a wider angle of view than a conventional camera, as shown in FIG. 1. However, the nonlinear properties resulting from the semi-spherical optical lens mapping make the resolution along the circular boundary of the image very poor. This is problematic if the field of view corresponding to the circular boundary of the image represents an area, such as a ground or floor, where high image resolution is desired. Although the images acquired by fish-eye lenses may be adequate for certain low-precision visualization applications, these lenses still do not provide adequate distortion compensation. The high cost of the lenses as well as the distortion problem prevent the fish-eye lens from widespread application.

To remedy the problems presented by the fish-eye lenses, large FOVs may be obtained by using multiple cameras in the same system, each camera pointing in a different direction. However, seamless integration of multiple images is further complicated by the fact that the images produced by each camera each has a different center of projection. Another possible solution for increasing the FOV of an imaging system is to rotate the entire imaging system about its center of projection, thereby obtaining a sequence of images that are acquired at different camera positions to be joined together to obtain a panoramic view of the scene. Rotating imaging systems, however, require the use of moving parts and precision positioning devices, making them cumbersome and expensive. A more serious drawback is that rotating imaging systems cannot obtain multiple images with wide FOV simultaneously. In both the multiple camera and rotating camera systems, obtaining complete wide FOV images can require an extended period of time, making these systems inappropriate for applications requiring real-time imaging of moving objects. Further, none of the above-described systems can generate three-dimensional (3D) omnidirectional images.

There is a long-felt need for an omnidirectional imaging system that can obtain 3D omnidirectional images in real-time without encountering the disadvantages of the systems described above.

### SUMMARY OF THE INVENTION

Accordingly, the present invention is directed to an efficient omnidirectional image processing method and system that can obtain, in real-time, non-distorted perspective and panoramic images and videos based on the real-time omnidirectional images acquired by omnidirectional image sensors. Instead of solving complex high-order nonlinear equations via computation, the invention uses a mapping matrix to define a relationship between pixels in a user-defined perspective or panoramic viewing window and pixel locations on the original omnidirectional image source so that the computation of the non-distorted images can be performed in real-time at a video rate (e.g., 30 frames per second). This mapping matrix scheme facilitates the hardware implementation of the omnidirectional imaging algorithms.

In one embodiment, the invention also includes a change/motion detection method using omnidirectional sequential images directly from the omnidirectional image source. Once a change is detected on an omnidirectional image, direction and configuration parameters (e.g., zoom, pan, and tilt) of a perspective viewing window can be automatically determined. The omnidirectional imaging method and apparatus of the invention can therefore offer unique solutions to many practical systems that require a simultaneous 360 degree viewing angle and three dimensional measurement capability.

### BRIEF DESCRIPTION OF THE DRAWINGS

FIG. 1 is a diagram comparing the fields of view between a conventional camera, a panoramic camera, and an omnidirectional camera;

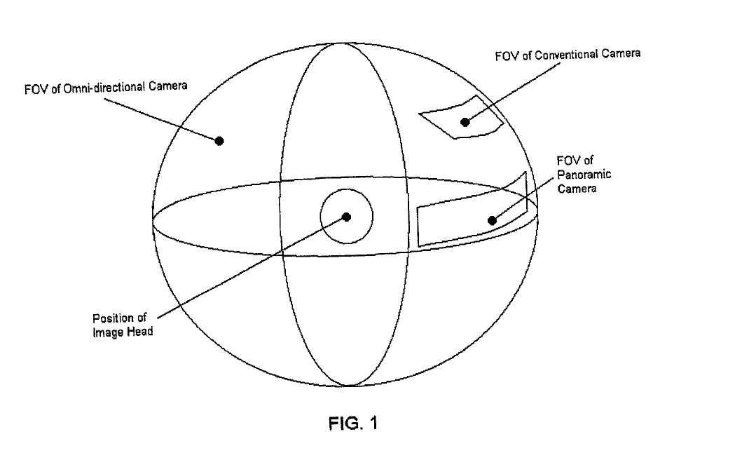

FIGS. 2a, 2b and 2c are examples of various reflective convex mirrors used in omnidirectional imaging;

FIG. 3 illustrates one manner in which an omnidirectional image is obtained from a convex mirror having a single virtual viewpoint;

FIG. 4 illustrates the manner in which one embodiment of the invention creates a mapping matrix;

FIGS. 5a and 5b illustrate configuration parameters of a perspective viewing window;

FIG. 6 is a block diagram illustrating a process for establishing a mapping matrix according to one embodiment of the present invention;

FIG. 7 is a representative diagram illustrating the relationship between a user-defined panoramic viewing window and corresponding pixel values;

FIG. 8 is a block diagram illustrating a change/motion scheme using omnidirectional images;

FIG. 9 is a diagram illustrating one way in which a direction of a desired area is calculated and automatically focused based on the process shown in FIG. 8;

FIG. 10 is a perspective view of a voice-directed omnidirectional camera to be used in the present invention;

FIG. 11 is a block diagram illustrating a voice directed perspective viewing process;

FIG. 12 is a block diagram of the inventive system incorporating an internet transmission scheme;

FIG. 13 is a representative diagram of Internet communication server architecture according to the inventive system;

FIG. 14 is a representative diagram of a server topology used in the present invention;

FIGS. 15a and 15b are flowcharts of server programs used in the present invention; and

FIG. 16 is a representative diagram of the invention used in a two-way communication system.

### DESCRIPTION OF THE PREFERRED EMBODIMENTS

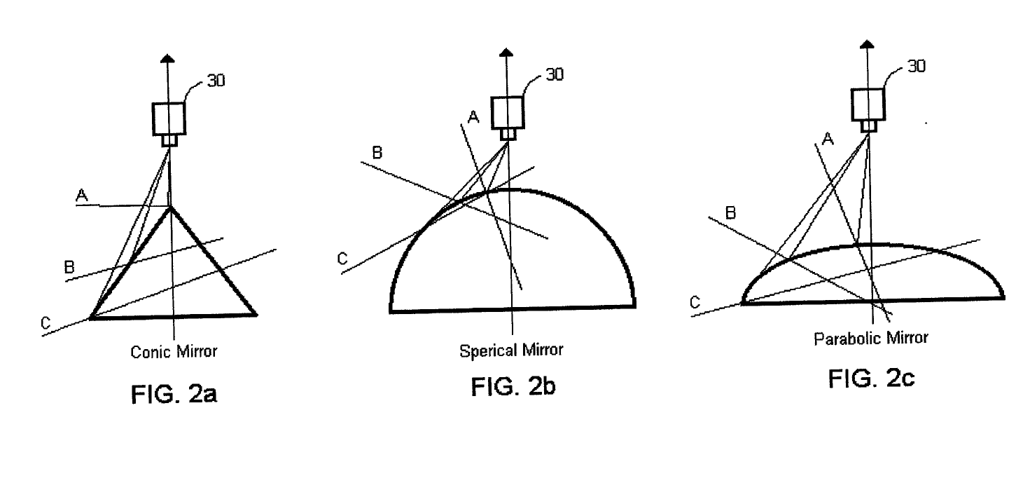

To dramatically increase the field of view of an imaging system, the present invention employs a reflective surface (i.e., convex mirror) to obtain an omnidirectional image. In particular, the field of view of a video camera can be greatly increased by using a reflective surface with a properly designed surface shape that provides a greater field of view than a flat reflective surface. There are a number of surface profiles that can be used to produce an omnidirectional FOV. FIGS. 2a, 2b, and 2c illustrate several examples of convex reflective surfaces that provide increased FOV, such as a conic mirror, spherical mirror, and parabolic mirror, respectively. The optical geometry of these convex mirrors provides a simple and effective means to convert a video camera's planar view into an omnidirectional view around the vertical axis of these mirrors without using any moving parts.

FIGS. 2a through 2c appear to indicate that any convex mirror can be used for omnidirectional imaging; however, a satisfactory imaging system according to the invention must meet two requirements. First, the system must create a one-to-one geometric correspondence between pixels in an image and points in the scene. Second, the convex mirror should conform to a “single viewpoint constraint”; that is, each pixel in the image corresponds to a particular viewing direction defined by a ray from that pixel on an image plane through a single viewing point such that all of the light rays are directed to a single virtual viewing point. Based on these two requirements, the convex mirrors shown in FIGS. 2a through 2c can increase the field of view but are not satisfactory imaging devices because the reflecting surfaces of the mirrors do not meet the single viewpoint constraint, which is desirable for a high-quality omnidirectional imaging system.

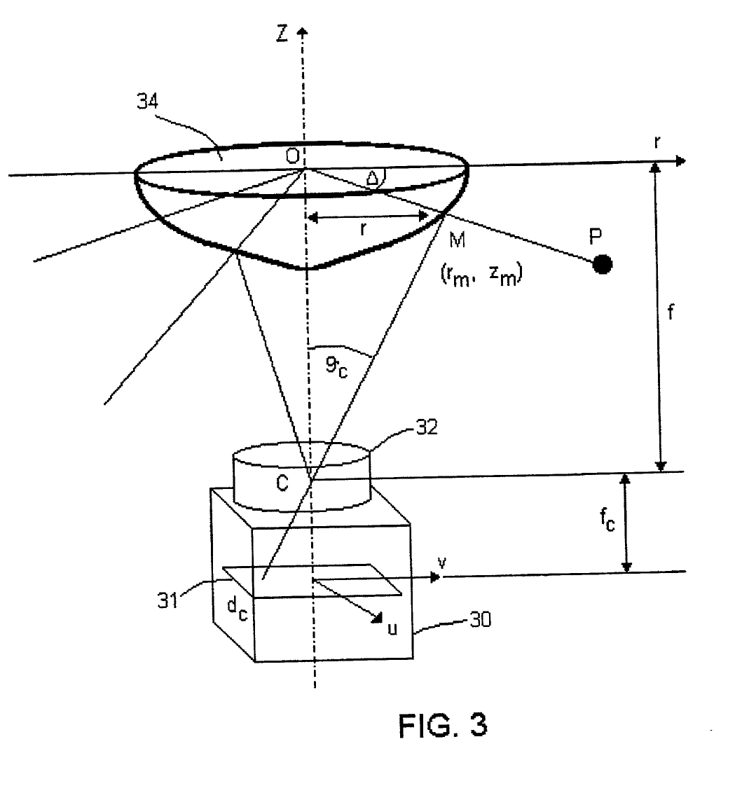

The preferred design for a reflective surface used in the inventive system will now be described with reference to FIG. 3. As noted above, the preferred reflective surface will cause all light rays reflected by the mirror to pass through a single virtual viewpoint, thereby meeting the single viewpoint constraint. By way of illustration, FIG. 3 shows a video camera 30 having an image plane 31 on which images are captured and a regular lens 32 whose field of view preferably covers the entire reflecting surface of the mirror 34. Since the optical design of camera 30 and lens 32 is rotationally symmetric, only the cross-sectional function z(r) defining the mirror surface cross-section profile needs to be determined. The actual mirror shape is generated by the revolution of the desired cross-section profile about its optical axis. The function of the mirror 34 is to reflect all viewing rays coming from the video camera's 30 focal point C to the surface of physical objects in the field of view. The key feature of this reflection is that all such reflected rays must have a projection towards a single virtual viewing point at the mirror's focal center, labeled as O. In other words, the mirror should effectively steer viewing rays such that the camera 30 equivalently sees the objects in the world from a single viewpoint O.

A hyperbola is the preferred cross-sectional shape of the mirror 34 because a hyperbolic mirror will satisfy the geometric correspondence and single viewpoint constraint requirements of the system. More particularly, the extension of any ray reflected by the hyperbolic curve and originating from one of the curve's focal points passes through the curve's other focal point. If the mirror 34 has a hyperbolic profile, and a video camera 30 is placed at one of the hyperbolic curve's focal points C, as shown in FIG. 3, the imaging system will have a single viewpoint at the curve's other focal point O. As a result, the system will act as if the video camera 30 were placed at the virtual viewing location O.

The mathematical equation describing the hyperbolic mirror surface profile is:

$$\frac{{( z + c )}^{2}}{{b}^{2}} + \frac{{r}^{2}}{{a}^{2}} = 1 , where c = \sqrt{{a}^{2} + {b}^{2}} and f = 2 c \qquad ( 1 )$$

As a result, the unique reflecting surface of the mirror 34 causes the extension of the incoming light ray sensed by the camera 30 to always pass through a single virtual viewpoint O, regardless of the location of the projection point M on the mirror surface.

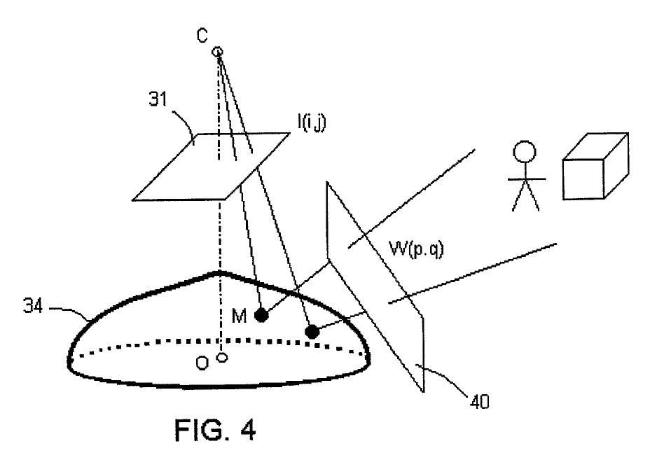

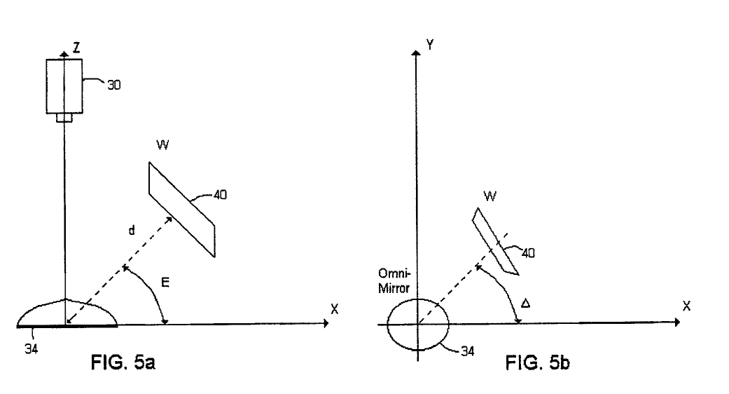

The image obtained by the camera 30 and capture on the camera's image plane 31 will exhibit some distortion due to the non-planar reflecting surface of the mirror 34. To facilitate the real-time processing of the omnidirectional image, the inventive system uses an algorithm to map the pixels from the distorted omnidirectional image on the camera's image plane 31 onto a perspective window image 40 directly, once the configuration of the perspective or panoramic window is defined. As shown in FIG. 4, a virtual perspective viewing window 40 can be arbitrarily defined in a three-dimensional space using three parameters: Zoom, Pan and Tilt (d, α, β). FIGS. 5a and 5b illustrate the definition of these three parameters. More particularly, Zoom is defined as the distance of the perspective window plane W 40 from the focal point of the mirror 34, Pan is defined as the angle between the angle D between the x-axis and the projection of the perspective window's W 40 normal vector onto the x-y plane, and Tilt is defined by the angle E between the x-y plane and the perspective window's W 40 normal vector. All of these parameters can be adjusted by the user.

In addition to the Zoom, Pan and Tilt parameters (d, α, β), the user can also adjust the dimensions of the pixel array (i.e., number of pixels) to be displayed in the perspective viewing window. Once the perspective viewing window W 40 is defined, the system can establish a mapping matrix that relates the pixels in the distorted omnidirectional image I(i,j) to pixels W(p,q) in the user-defined perspective viewing window W 40 to form a non-distorted perspective image. The conversion from the distorted omnidirectional image into a non-distorted perspective image using a one-to-one pixel correspondence between the two images is unique.

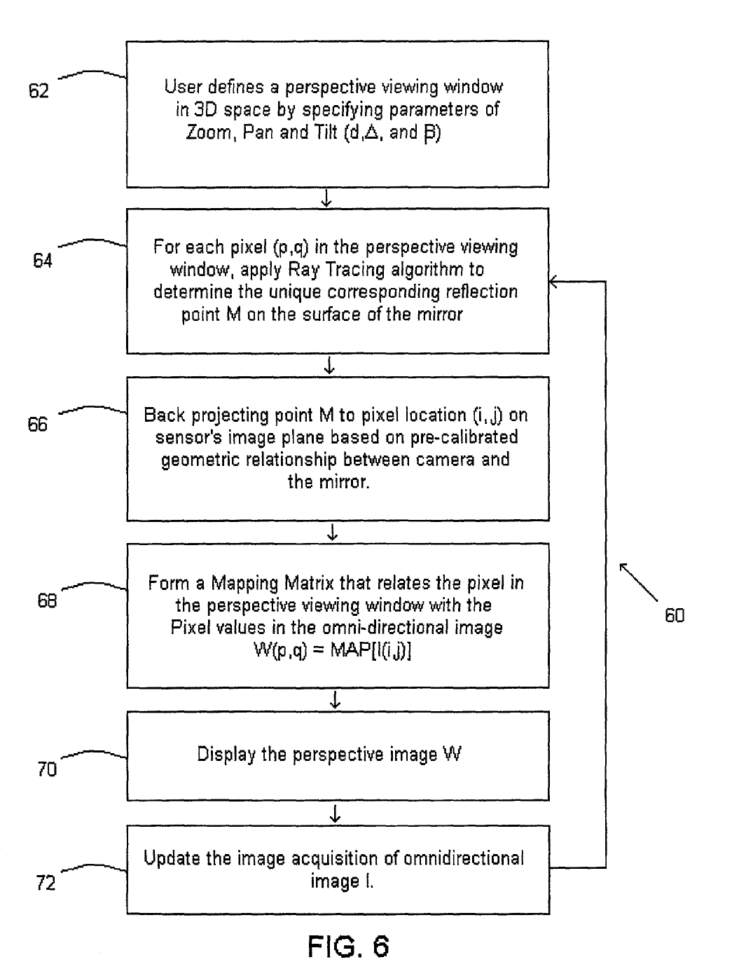

FIGS. 6 is a block diagram illustrating one method 60 for establishing a mapping matrix to convert the distorted omnidirectional image into the non-distorted perspective image in the perspective viewing window W. As noted above, the user first defines a perspective viewing window in three-dimensional space by specifying the Zoom, Pan and Tilt parameters at step 62 to specify the configuration of the perspective window. Providing this degree of flexibility facilitates the wide range selections of desirable viewing needs by the user.

Once these parameters are defined, a mapping matrix can be generated based on the fixed geometric relationship of the imaging system. More particularly, a “ray tracing” algorithm is applied for each pixel W(p,q) in the perspective viewing window to determine the corresponding unique reflection point M on the surface of the mirror at step 64, thereby obtaining a projection of each pixel in W onto the surface of the omni-mirror. In the ray tracing algorithm, a straight line from the pixel location on W denoted as W(p,q) to the focal center O of the omni-mirror is recorded as M(p,q), as illustrated in FIG. 5.

Once each perspective viewing window pixel is linked to a reflection point M(p,q), the system projects each reflection point M(p,q) back to the focal point of the imaging sensor and then determines the corresponding pixel location I(i,j) on the sensor's image plane based on the geometric relationship between the camera and mirror at step 66. More particularly, the projection line from the M(p,q) to C would be intercepted by the image plane I at a pixel location of (i,j). The one-to-one mapping relationship therefore can be established between W(p,q) and I(i,j) such that for each pixel in the perspective viewing window W, there is a unique pixel location in the omnidirectional image that corresponds to the W(p,q), allowing the pixel values (e.g., RGB values) in the omnidirectional image to be used in the counterpart pixels in the perspective window.

At step 68, a mapping matrix MAP is established to link each pixel in the perspective viewing window W with the corresponding pixel values in the omnidirectional image such that W(p,q)= MAP [I(i,j)]. The dimension of the mapping matrix MAP is the same as that of the pixel arrangement in the perspective viewing window W 40, and each cell of the mapping matrix stores two index values (i,j) of the corresponding pixel in the omnidirectional image I at step 72.

Once the mapping matrix MAP has been established, the real-time image-processing task is greatly simplified and can be conducted in a single step at step 70 by applying the mapping matrix MAP to each pixel I(i,j) in the omnidirectional image I to determine the pixel values for each corresponding pixel in the perspective viewing window W. Further, each time a new omnidirectional image I is acquired, a look-up table operation can be performed to generate the non-distorted perspective image for display in the perspective viewing window W at step 72.

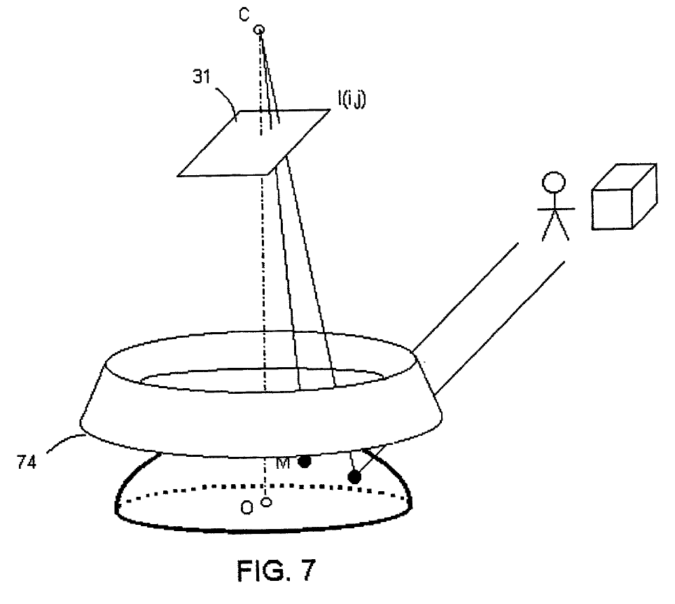

Referring now to FIG. 7, the perspective viewing window in the inventive system can be a panoramic viewing window 74 with few modifications to the system. The image processing procedure using a panoramic viewing window 74 is very similar to the process described above with respect to the perspective viewing window 40. As shown in FIG. 7, a virtual panoramic viewing window 74 can be arbitrarily defined in three-dimensional space by a user using three parameters: Zoom and Tilt (d, β), subject to the only constraint that the normal of the window plane should point directly toward the focal center of the reflective mirror, as shown in FIG. 7. In addition, to the Zoom and Tilt parameters (d, α, β), the user can also adjust the dimensions of the pixel array (e.g. the number of pixels) to be displayed in the panoramic viewing window 74. Once these parameters are defined, a mapping matrix can be generated based on the fixed geometric relationship of the imaging system in the same manner explained above with respect to FIG. 6 to generate a non-distorted image in the panoramic viewing window 74.

Note that due to the non-linear geometric relationship between the perspective viewing window image W(p,q) and the omnidirectional image I(i,j), the intercepting point of the back-projection of the reflection point M(p,q) may not correspond directly with any pixel position on the image plane. In such cases, the inventive system may use one of several alternative methods to obtain the pixel values for the perspective viewing window image W(p,q). One option is to use the pixel values of the closest neighborhood point in the omnidirectional image I without any interpolation by, for example, quantizing the calculated coordinate values into integers and using the integer values as the pixel values for the perspective viewing window pixel W(p,q). Although this method is the fastest way to obtain the pixel values, it does possess inherent quantization errors.

A less error-prone method is to use linear interpolation to resolve the pixel values of calculated fractional coordinate values. For example, if the calculated coordinate value (iₒ, jₒ) falls between the grid formed by (i,j), (i,j+1), (i+1,j), and (i+1, j+1) the corresponding W(p,q) value can be obtained from the following linear interpolation formula:

W(p,q)=(jₒ−j)·[(iₒ−i)·I(i,j)+(i+1−iₒ)· I(i+1,j)] +(j+1−jₒ)·[(iₒ−i)·I(i,j+1)+(i+1−iₒ·I(i+1,j+1)] (2)

Yet another alternative is to use other types of interpolation schemes to enhance the fidelity of the converted images, such as average, quadratic interpolation, B-spline, etc.

The actual image-processing algorithms implemented for linking pixels from the omnidirectional image I(i,j) to the perspective viewing window W(p,q) have been simplified by the inventive system from complicated high order non-linear equations to a simple table look-up function, as explained above with respect to FIG. 6. Note that before the actual table look-up function is conducted, the parameter space needs to be partitioned into a finite number of configurations. In the case of perspective viewing window, the parameter space is three dimensional defined by the Zoom, Pan and Tilt diameters (d, α, β,), while in the case of a panoramic viewing window, the parameter space is two dimensional defined only by the Zoom and Tilt parameters (d, α).

For each possible configuration in the parameter space, a mapping matrix is pre-calculated. The mapping matrix MAP having a dimension of (N, M) can be stored in the following format:

$$MAP = [ \begin{matrix}( {i}_{1 , 1} , {j}_{1 , 1} ) & ( {i}_{1 , 2} , {j}_{1 , 2} ) & ( {i}_{1 , 3} , {j}_{1 , 3} ) & ⋯ & ( {i}_{1 , M} , {j}_{1 , M} ) \\ ( {i}_{2 , 1} , {j}_{2 , 1} ) & ( {i}_{2 , 2} , {j}_{2 , 2} ) & ( {i}_{2 , 3} , {j}_{2 , 3} ) & ⋯ & ( {i}_{2 M} , {j}_{2 , M} ) \\ ( {i}_{3 , 1} , {j}_{3 , 1} ) & ( {i}_{3 , 2} , {j}_{3 , 2} ) & ( {i}_{3 , 3} , {j}_{3 , 3} ) & ⋯ & ( {i}_{3 , M} , {j}_{3 , M} ) \\ ⋮ & ⋮ & ⋮ & ⋰ & ⋮ \\ ( {i}_{N , 1} , {j}_{N , 1} ) & ( {i}_{N , 2} , {j}_{N , 2} ) & ( {i}_{N , 3} , {j}_{N , 3} ) & ⋯ & ( {i}_{N , M} , {j}_{N , M} )\end{matrix} ] \qquad ( 3 )$$

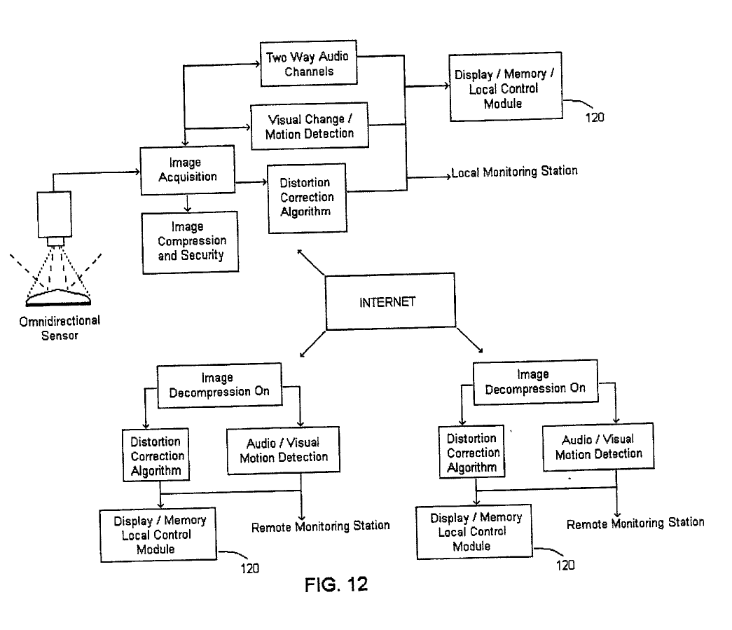

All possible or desired mapping matrices MAP are pre-stored in a set of memory chips with the system, such as chips in the “display/memory/local control logic module 120 as shown in FIG. 12, in a manner that is easily retrievable. Once a user selects a viewing window configuration, the stored MAP matrix is retrieved and used to compute the image of the viewing window:

$$W = [ \begin{matrix}I ( {i}_{1 , 1} , {j}_{1 , 1} ) & I ( {i}_{1 , 2} , {j}_{1 , 2} ) & I ( {i}_{1 , 3} , {j}_{1 , 3} ) & ⋯ & I ( {i}_{1 , M} , {j}_{1 , M} ) \\ I ( {i}_{2 , 1} , {j}_{2 , 1} ) & I ( {i}_{2 , 2} , {j}_{2 , 2} ) & I ( {i}_{2 , 3} , {j}_{2 , 3} ) & ⋯ & I ( {i}_{2 M} , {j}_{2 , M} ) \\ I ( {i}_{3 , 1} , {j}_{3 , 1} ) & I ( {i}_{3 , 2} , {j}_{3 , 2} ) & I ( {i}_{3 , 3} , {j}_{3 , 3} ) & ⋯ & I ( {i}_{3 , M} , {j}_{3 , M} ) \\ ⋮ & ⋮ & ⋮ & ⋰ & ⋮ \\ I ( {i}_{N , 1} , {j}_{N , 1} ) & I ( {i}_{N , 2} , {j}_{N , 2} ) & I ( {i}_{N , 3} , {j}_{N , 3} ) & ⋯ & I ( {i}_{N , M} , {j}_{N , M} )\end{matrix} ] \qquad ( 4 )$$

where I is the omnidirectional image.

Note that the “display/memory/local control module” 120 shown in FIG. 12 is preferably designed to have a built-in memory, image display, user interface, and self contained structure such that it can operate without relying upon a separate PC.

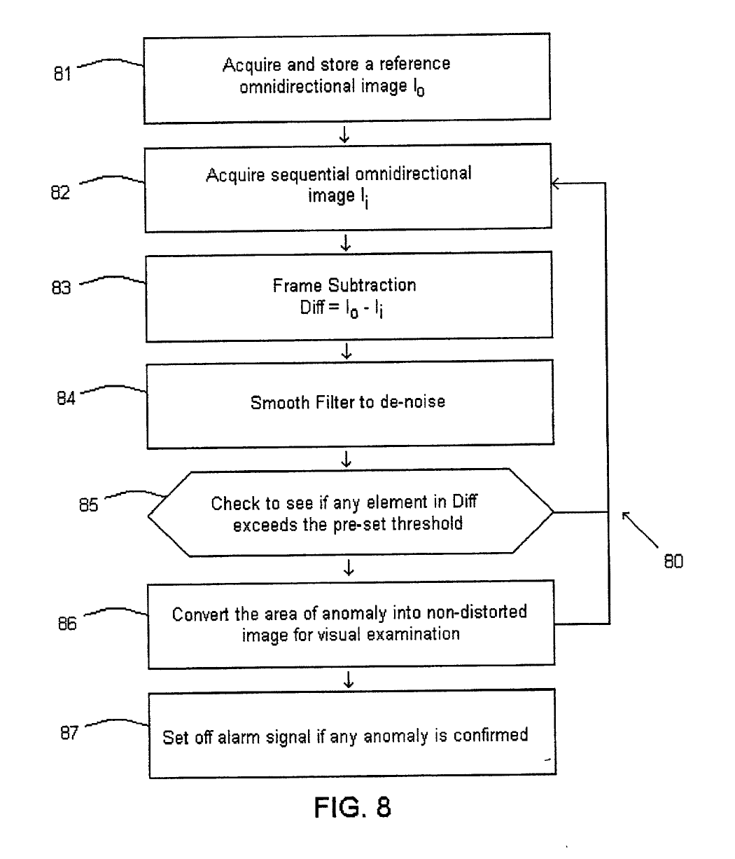

The present invention may also include a change/motion detection scheme 80 based on frame subtraction, as illustrated in FIG. 8. This feature is particularly useful in security applications. This particular embodiment conducts frame subtraction using sequential omnidirectional images directly instead of using converted perspective images. The sequential omnidirectional images in the description below are denoted as I₁, I₂, . . . , Iₙ. As can be seen in FIG. 8, the motion detection process first involves acquiring and storing a reference frame of an omnidirectional image, denoted as Iₒ, Next, a sequential omnidirectional image I₁ is acquired at step 82 and a frame subtraction is calculated at step 83 as follows to obtain a residual image “DIFF”:

DIFF=I₀−I₁ (5)

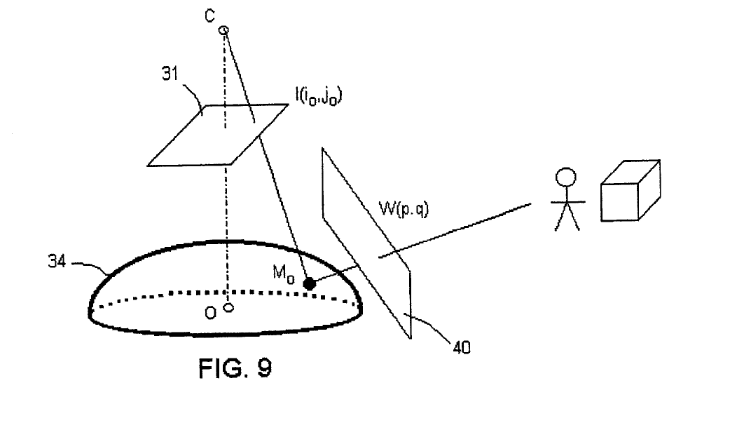

Once the residual image “DIFF” has been calculated, a smooth filter algorithm is applied to the residual image to eliminate any spike that may cause a false alarm. If any element in the residual image “DIFF” is still larger than a pre-set threshold value after the smoothing step at step 85, the element indicates the presence of, for example, an intruder or other anomaly. The system converts the area of the image around the suspected anomalous pixels into a non-distorted perspective image at step 86 for closer visual examination. More particularly, as shown in FIG. 9, the direction of the suspected anomalous pixel area can be calculated and used as the parameters of the perspective viewing window W so that the perspective viewing window W is automatically focused on the suspected anomalous pixel area. An optional alarm can be activated at step 87 if the image in the perspective viewing window confirms the presence of suspicious or undesirable activity.

More particularly, the direction of suspected anomalous area can be calculated and fed to the parameter of perspective viewing window so that the viewing window is automatically focused on the suspected area. Automatic zoom, pan and tilt adjustment can be conducted by first determining the center of the suspected area in the omnidirectional image by calculating the center of gravity of the suspected pixels as follows:

$${i}_{0} = \frac{{\sum }_{i = 1}^{N} {i}_{i}}{N} , {j}_{0} = \frac{{\sum }_{i = 1}^{N} {j}_{i}}{N} , \qquad ( 6 )$$

A pin-hole model of the camera 30 is then used to trace the impinging point on the mirror of the projection ray that originates from camera's focal point and passes through the central pixel (iₒ,jₒ). The impinging point on the mirror is denoted as Mₒ. The normal of the perspective viewing window is then determined by using the projection ray that originates from the camera's focal point and passes through the impinging point Mₒ. This normal vector effectively defines the pan and tilt parameters of the perspective viewing window. The zoom parameter can be determined based on the boundary of the suspected pixel sets using the same ray tracing method.

Using the omnidirectional images in change/motion detection is much more efficient than other change/motion detection schemes because the omnidirectional images contain optically compressed images of the surrounding scene. The entire area under the surveillance can therefore be checked in one operation.

The system described above can be implemented using an omnidirectional image sensor such as the camera 30, with an acoustic sensor such as a selectively switchable microphone, directional microphone, or microphone array 104, so that the viewing direction of the perspective window can be adjusted to focus on, for example, a person speaking. This function is particularly useful in teleconferencing applications, where there is a need for detecting and focusing the camera toward the active speaker in a meeting. Combining the microphone array 104 with the omnidirectional image sensor 30, a voice-directed viewing window scheme and allows for automatic adjustment of a perspective viewing window toward the active speaker in a meeting based on the acoustic signals detected by an array of spatially-distributed microphones. A source of sound reaches each microphone in the array 104 with different intensities and delays, allowing estimation of the spatial direction of a sound source using the differences in received sound signals among the microphones 104. The estimated direction of the sound source can then be used to control the viewing direction of any perspective viewing window.

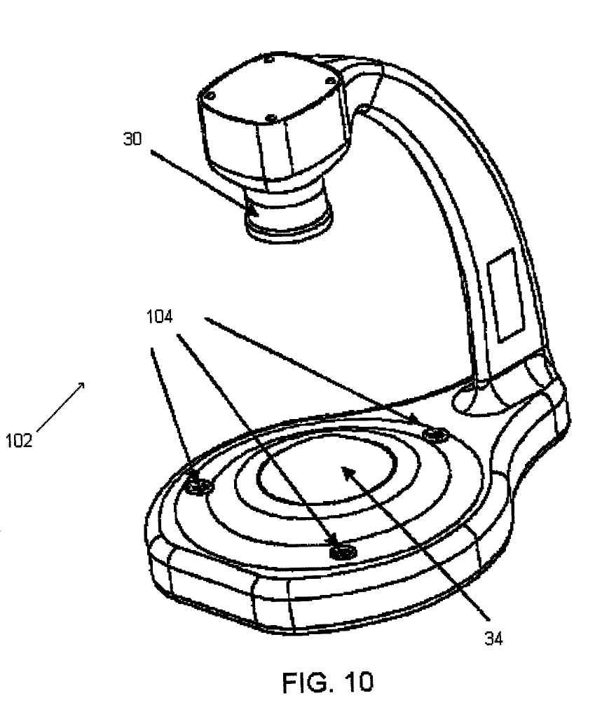

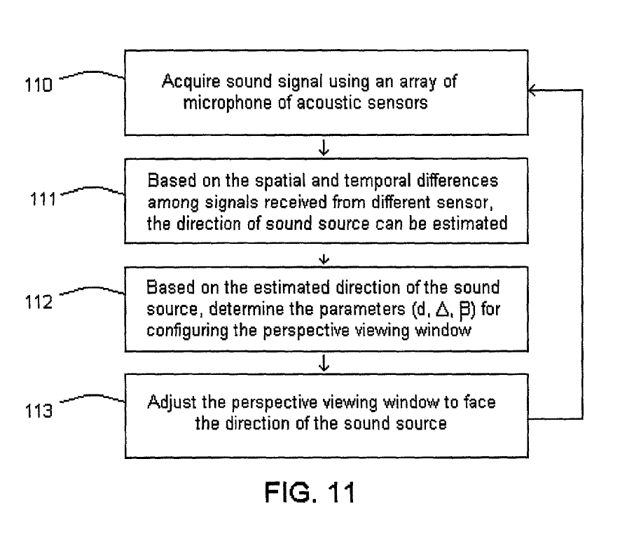

FIG. 11 is a flowchart illustrates one embodiment of the procedures used to focus the perspective viewing window on an active speaker using the apparatus shown in FIG. 10. First, the microphone array 104 is used to acquire a sound signal at step 110. As can be seen in FIG. 11, multiple numbers of microphones can placed along the periphery of the image unit to form the array.

Next, based on the spatial and temporal differences among the sound signals received by the microphones in the array, the direction of the sound source is estimated at step 111. One possible method for conducting the estimation is as follows: if the acoustic signal detected by the k^{th} microphone unit is denoted as sₖ, k= 1,2, . . . n, the direction of an active speaker can be determined by the vector summation of all detected acoustic signals:

V=s₁\overline{ν}₁+s₂\overline{ν}₂+s₃\overline{ν}₃+. . . +sₙ\overline{ν}ₙ (7)

Once the estimated direction of the sound source has been determined, the system determines the zoom, tilt and pan parameters for configuring the perspective viewing window based on the estimated sound source direction at step 112. The perspective viewing window position is then adjusted to face the direction of the sound source at step 113.

The acoustic sensors 162 can be built-in with the omnidirectional camera or operated separately. The direction estimation signals need to be and preferably are fed into the host computer so that the omnidirectional camera software can use its input in real-time operation.

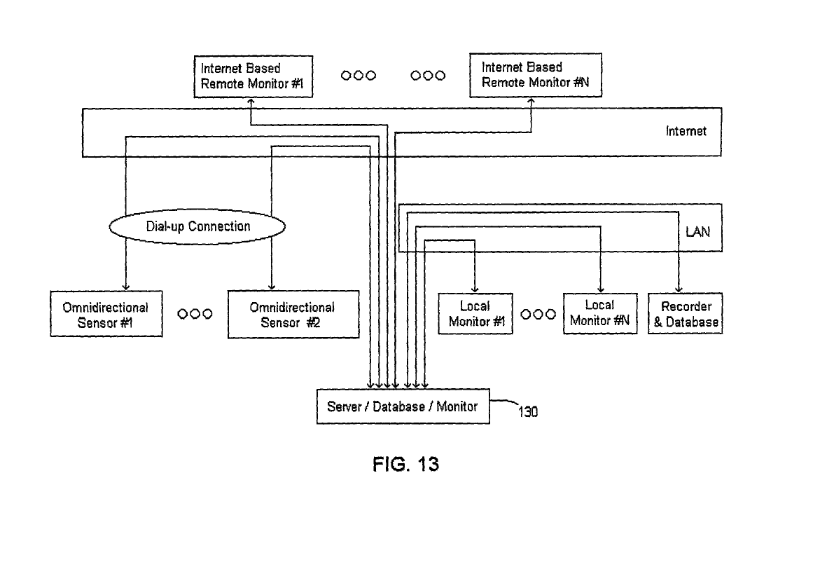

Referring now to FIGS. 12 and 13, the inventive omnidirectional imaging system can include an image transmission system that can transmit images and/or data over the Internet. FIG. 12 is a block diagram of the overall system incorporating an Internet transmission scheme, while FIG. 13 is a representative diagram of a system architecture in an Internet-based omnidirectional image transmission system according to the present invention. This embodiment of the present invention uses a server 130 to provide the information communication services for the system. The server 130 simplifies the traffic control and reduces the load of entire networks, making it a more desirable choice than bridge or router devices.

An Internet-based imaging system is particularly useful in medical applications to allows transmission of images or data of a patient to a physician or other medical practitioner over the Internet. The server provides additional convenience, eliminating the need for the patient to know where to send his/her data and to send the data to more than one specialist, by allowing the patient to transfer the data package only once to the server with an appended address list. The server would then distribute the data package for the patient, reducing network traffic load and simplifying data transfer.

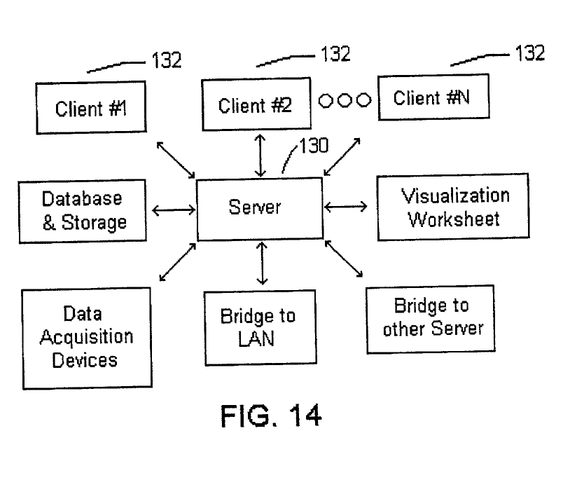

FIG. 14 is a representative diagram of the topology of the server 130 in the Internet-based imaging system of the invention. Clients 132 the server 130 may include patients, telemedicine users and practitioners, medical information visualization systems, databases, archival, and retrieving systems. The basic function of the server 130 is to manage the communication between its clients 132, e.g., receive, transfer, and distribute the medical signals and records, and control the direction, priority, and stream rate of the information exchange. From a client's point of view, the client only needs to send and/or receive date to/from the server to communicate with all designated service providers.

In accordance with the preferred server architecture of the Internet-based imaging system, the communication protocol for the server 130 should include connection and data packages. The preferred connection protocol for the server is a “socket” protocol, which is an interface-to-Internet application layer. As can be seen in FIG. 14, the network design is a server/client structure having a “star-topology” structure.

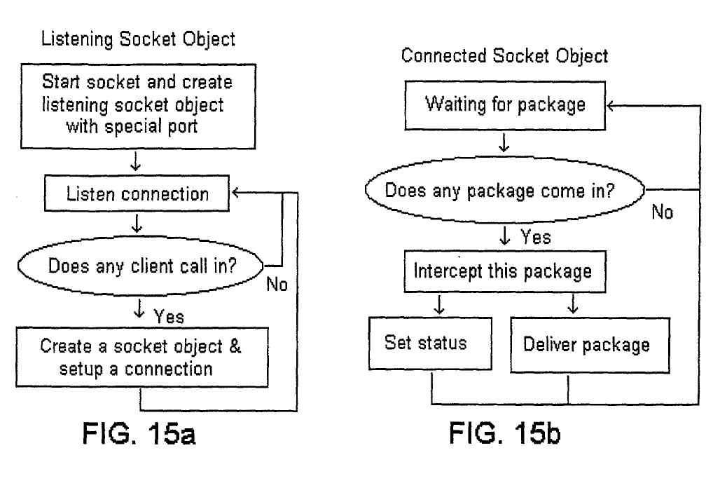

Programming task for a client/server communication application should include two components: a server program (FIG. 15a) and a client program (FIG. 15b). The tele-monitoring applications require the server program to be able to provide services for various clients, such as the patients, medical specialists, emergency services, and storage devices. To effectively use the server services, the client program should provide a proper interface in order to work with the server. By considering these requests, a structure of the program and the interface function of the client program is disclosed herein.

Using object-oriented programming, the server program consists of an object of listening-socket class and many objects of client-socket class. FIGS. 15a and 15b show one example of possible flowcharts for the server program. Whenever a client makes a call to the server, the listening-socket object will accept the call and create a client-socket object, which will keep the connection with the client and serve the client's request. When a client-socket object receives a package from its client, it will interpret the package and reset the communication status or deliver the package to the other client according to the request from the client.

Beside the object-oriented function, the server also manages the traffic of communication among the clients. The server program makes up a table to store communication information of all the client socket objects, including connection status, client's name, group number, receiving inhabit bits, bridge status, and bridge owner.

The server 130 can also provide simple services of database accessing. If there is any database provided by an application, the server could deliver the client's request to that application and transfer data back to the client. In order for the server 130 to deliver or distribute the information to the correct client destinations, the data package format should include information about the destination, address of the client, the length of the data, and the data to be transferred.

The inventive system may also include the capability to transfer video signals and images via the Internet. Note that some applications incorporating remote tele-monitoring do not require a video rate of image transmission, thereby making it possible to transmit high-resolution images directly as well as with both loss-less and lossy compression schemes.

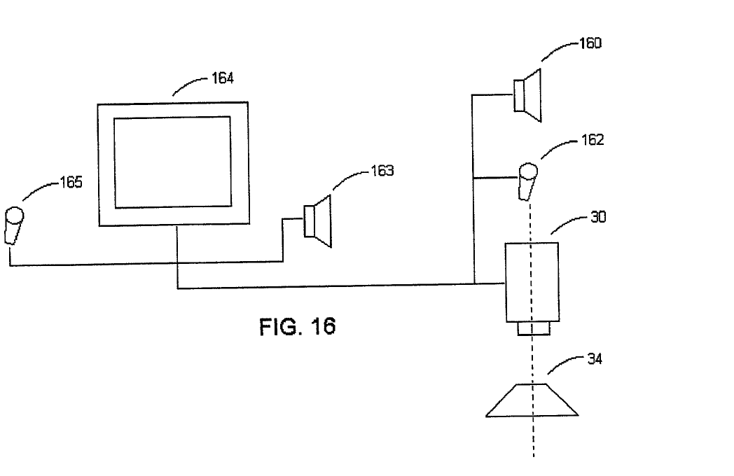

If desired, the inventive omnidirectional imaging system can be modified to provide two-way communication between the omnidirectional imaging system and a remote observer. This capability may be particularly useful in, for example, security applications. FIG. 16 is a representative diagram of this embodiment. To provide a channel for two-way communication, the omnidirectional imaging system may incorporate a speaker 160 and microphone 162 at the same location as the camera 30 and mirror 34. Audio signals are transmitted from the microphone 162 to a speaker 163 located at a remote display device 164 on which an image is displayed using the perspective window W 40 explained above. The audio transmission can be conducted via any known wired or wireless means. In this way, the user can both watch the omnidirectional image and hear sounds from the site at which the omnidirectional image is being taken.

A second microphone 165 provided at the remote display 164 location can also be used to transmit audio signals from the remote display 164 location to the speaker 160 located with the omnidirectional camera system. In this way, a user can speak from the remote monitoring location and be heard at the omnidirectional camera system location. Note that the network providing this two-way audio transmission can be the Internet if the remote user is monitoring the output of the omnidirectional camera system via the Internet.

Alternatively, the audio communication between the camera system and the remote monitoring location can be one-way communication as dictated by the particular application involved. For example, if the user only wishes to hear the sound at the camera system location (and not be heard), the camera system may only incorporate a microphone and not a speaker. The output of the microphone is then transmitted to the remote monitoring location and rendered audible to the user at that location as described above.

While the invention has been specifically described in connection with certain specific embodiments thereof, it is to be understood that this is by way of illustration and not of limitation, and the scope of the appended claims should be construed as broadly as the prior art will permit.

What is claimed is:

1. A method for generating a selectable perspective view of a portion of a hemispherical image scene, comprising the steps of:
acquiring an omnidirectional image on an image plane using a reflective mirror that satisfies a single viewpoint constraint and an image sensor;
defining a perspective viewing window based on configuration parameters;
defining a predetermined geometric relationship between the reflective mirror and the image plane; and
mapping each pixel in the perspective window with a corresponding pixel value in the omnidirectional image on the image plane using the configuration parameters.

2. The method of claim 1, wherein the configuration parameters defined in the defining step include at least one of a zoom distance defined as the distance from the focal point of said reflective mirror to said window, a pan angle defined as the angle between the x axis and a line through the focal point of said reflective mirror perpendicular to the x-y plane and a tilt angle defined as the angle between the x-y plane and a vector normal to said window.

3. The method of claim 2, wherein the defining step is conducted via a user interface through which a user enters data corresponding to at least one of a desired zoom distance, pan angle, or tilt angle.

4. The method of claim 1, wherein the mapping step includes the step of generating a mapping matrix by:
applying a ray tracing algorithm to each pixel in the perspective viewing window to determine a corresponding reflection point on the reflective mirror; and
projecting each reflection point to a focal point of the image sensor to determine the corresponding location in the omnidirectional image on the image plane.

5. The method of claim 4, further comprising the step of storing the mapping matrix in a module having a memory.

6. The method of claim 1 wherein the step of defining a perspective viewing window defines the perspective viewing window as a panoramic viewing window.

7. The method of claim 1, further comprising the steps of:
calculating a residual image based on a difference between a reference omnidirectional image and a sequential omnidirectional image;
determining if the residual image contains any value that exceeds a predetermined threshold; and
classifying any value that exceeds the predetermined threshold as an anomaly.

8. The method of claim 7, further comprising the steps of:
calculating the configuration parameters for the perspective viewing window from the anomaly; and
selectively focusing the perspective viewing window on the anomaly using the calculated configuration parameters.

9. The method of claim 7, further comprising the step of activating an alarm if at least a portion of the residual image exceeds a predetermined threshold.

10. The method of claim 1, further comprising the steps of:
detecting a location of a sound source in the image scene; and
adjusting the perspective viewing window based on the detected location of the sound source.

11. The method of claim 1, further comprising the step of transmitting the omnidirectional image via the Internet.

12. The method of claim 11, wherein the transmitting step is conducted through a server that receives the omnidirectional image and transmits the omnidirectional image to at least one client.

13. The method of claim 1, further comprising the step of forming a two-way transmission link between the image sensor and a remote display, wherein the two-way transmission link transmits at least one of the omnidirectional image, the perspective viewing window, and an audio signal.

14. An improved imaging apparatus for generating a two-dimensional image, comprising:
a reflective mirror configured to satisfy an optical single viewpoint constraint for reflecting an image scene;
an image sensor responsive to said reflective mirror and that generates two dimensional image data signals to obtain an omnidirectional image on an image plane; and
a controller coupled to the image sensor, wherein the controller defines a perspective viewing window and includes a mapping matrix generator that defines a geometric relationship between the image plane and the perspective viewing window such that at least a portion of the omnidirectional image on the image plane can be mapped to the perspective viewing window.

15. The improved imaging apparatus of claim 14, wherein the reflective mirror conforms to a single viewpoint constraint.

16. The improved imaging apparatus of claim 14, wherein the reflective mirror creates a one-to-one correspondence between pixels in the omnidirectional image and pixels in the perspective viewing window.

17. The improved imaging apparatus of claim 14, wherein the controller maps the omnidirectional image to the perspective viewing window by mapping each pixel in the perspective viewing window with a corresponding pixel value in the omnidirectional image.

18. The improved imaging apparatus of claim 14, wherein the parameters defining the perspective viewing window include at least one of a zoom distance defined as the distance from the focal point of said reflective mirror to said window, a pan angle defined as the angle between the x axis and a line through the focal point of said reflective mirror perpendicular to the x-y plane and a tilt angle defined as the angle between the x-y plane and a vector normal to the perspective viewing window.

19. The improved imaging apparatus of claim 18, further comprising a user interface through which a user enters data corresponding to at least one of a desired zoom distance, pan angle, or tilt angle.

20. The improved imaging apparatus of claim 14, wherein the controller generates the mapping matrix by applying a ray tracing algorithm to each pixel in the perspective viewing window to determine a corresponding reflection point on the reflective mirror and then projecting each reflection point to a focal point of the image sensor to determine the corresponding location on the omnidirectional image.

21. The improved imaging apparatus of claim 14, wherein the perspective viewing window is a panoramic viewing window.

22. The improved imaging apparatus of claim 10, further comprising a module having a memory for storing the mapping matrix.

23. The improved imaging apparatus of claim 22, wherein the module is a display/memory/local control module.

24. The improved imaging apparatus of claim 14, wherein the controller calculates a residual image based on a difference between a reference omnidirectional image and a sequential omnidirectional image to detect an anomaly and uses the anomaly to calculate parameters for the perspective viewing window so that the perspective viewing window focuses on the anomaly.

25. The improved imaging apparatus of claim 24, farther comprising an alarm that is activated if at least a portion of the residual image exceeds a predetermined threshold.

26. The improved imaging apparatus of claim 14, further comprising an acoustic sensor coupled to the controller for detecting a sound source within the image scene, wherein the controller adjusts the perspective viewing window based on a location of the sound source.

27. The improved imaging apparatus of claim 14, further comprising an image transmission system for transmitting the omnidirectional image via the Internet.

28. The improved imaging apparatus of claim 27, wherein the image transmission device includes a server that receives the omnidirectional image and transmits the omnidirectional image to at least one client.

29. The improved imaging apparatus of claim 10, further comprising:
a remote display coupled to the image sensor;
a first speaker and first microphone coupled to the image sensor; and
a second speaker and second microphone coupled to the remote display, wherein the first and second speakers and first and second microphones form a two-way transmission link between the image sensor and the remote display.
